(19) United States
(12) Patent Application Publication
(10) Pub. No.: US 2004/0181692 A1
(43) Pub. Date: Sep. 16, 2004

(54) Method and apparatus for providing network service information to a mobile station by a wireless local area network

(76) Inventors: Johanna Wild, Muenchen (DE); Rajesh Pazhyannur, Schaumburg, IL (US)

Correspondence Address: MOTOROLA, INC., 1303 EAST ALGONQUIN ROAD, IL01/3RD, SCHAUMBURG, IL, 60196

(21) Appl. No.: 10/755,800

(22) Filed: Jan. 12, 2004

Related U.S. Application Data
(60) Provisional application No. 60/439,743, filed on Jan. 13, 2003.

(51) Int. Cl. H04L 9/00

(52) U.S. Cl. 713/201

(57) ABSTRACT

A wireless local area network (WLAN) communication system that includes an access point in communication with a mobile station and at least one Authentication, Authorization, and Accounting (AAA) server provides an authentication process whereby a user of the mobile station may select a WLAN service provider from among one or more WLAN service providers and/or one or more 3GPP service providers before being authenticated and further to make a decision to subscribe to the services of the selected service provider based on network service information, other than or in addition to an Service Set Identifier (SSID), associated with the selected service provider.

### FILED OF THE INVENTION

The present invention relates generally to wireless local area networks and, in particular, to provision of network coverage, network accessibility, and network service information by a wireless local area network infrastructure to a mobile station.

### BACKGROUND OF THE INVENTION

Local area networks (LANs) allow organizations to share information over a high speed network that may be assembled with relatively inexpensive hardware components. LANs also provide for relatively inexpensive hardware connections to networks beyond the LAN by allowing multiple users within the LAN to connect to each of multiple networks outside of the LAN through an interface common to all users. Until recently, LANs were limited to hardwired infrastructure, requiring the user to physically connect to the LAN via a wired connection. However, with the recent growth of wireless telephony and wireless messaging, wireless communications have also been applied to the realm of LANs, resulting in the development of wireless local area networks (WLANs).

FIG. 1 is a block diagram of an exemplary wireless local area network (WLAN) communication system 100 of the prior art. Communication system 100 includes a WLAN that comprises a Basic Service Set (BSS) 104, which BSS in turn comprises one or more Access Points (APs) 106, 108 (two shown). Associated with BSS 104 is a Service Set Identifier (SSID), which SSID is common to, and stored by, each AP 106, 108 in BSS 104 and functions as an identifier of the BSS. The WLAN, and in particular each of the one or more APs 106 and 108, is coupled to an Authentication, Authorization, and Accounting (AAA) server 110 that provides authentication, authorization, and accounting services to the WLAN. AAA server 110 includes a database 112 that stores identifiers associated with each mobile station (MS) that is authorized to access the WLAN and further stores a password in association with each identifier.

When an MS 102 wishes to access the WLAN, the MS must first establish and configure a link with an AP of the one or more APs 106, 108, typically by actively or passively scanning the WLAN. In an active scan, MS 102 initiates the establishment and configuration of a link by broadcasting a Probe Request. The Probe Request includes a Service Set Identifier (SSID) and capabilities and data rates supported by the MS. Upon receiving the Probe Request each AP of the one or more APs 106, 108 determines whether the SSID included in the Probe Request is the same as the SSID associated with the AP. When the SSIDs are the same, the AP responds to the Probe Request by transmitting a Probe Response back to the MS that includes the SSID associated with the AP and capabilities and data rates supported by the AP. Based on the received Probe Responses, MS 102 selects a best AP, such as AP 106, of the one or more APs 106, 108 and transmits an Association Request to the selected AP 106 that includes the SSID and further includes the capabilities and data rates supported by the MS. Upon receiving the Association Request, AP 106 transmits an Association Response to MS 102 that includes an identifier uniquely associated with the AP, that is, an AP address, and the capabilities and data rate that will be supported by the AP, and establishes a link between the MS and the selected AP.

In a passive scan, instead of utilizing a Probe Request and a Probe Response, MS 102 may select an AP and transmit an Association Request to the selected AP in response to receiving a Beacon that is intermittently transmitted by each of the one or more APs 106, 108. Similar to the Probe Response, each Beacon includes the SSID associated with the AP and capabilities and data rates supported by the AP.

After a link is established between MS 102 and AP 106, MS 102 must be authenticated before the MS is authorized to transmit data traffic to AP 106, that is, is access to the WLAN is unblocked. FIG. 2 is a signal flow diagram 200 of a WLAN authentication process of the prior art. The authentication process begins when MS 102 transmits an EAPOL (Extensible Application Protocol Over LAN)-Start message 202 to the AP 106. In response to receiving EAPOL-Start message 202, AP 106 transmits an EAPOL-EAP (Extensible Application Protocol)-Request/Identity message 204 to the MS 102. EAPOL-EAP-Request/Identity message 204 requests authentication information from the MS, such as an identifier uniquely associated with the MS and a password. Upon receiving EAPOL-EAP-Request/identity message 204, MS 102 transmits an EAPOL-EAP-Response/Identity message 206 to AP 106 that provides the requested information.

Upon receiving EAPOL-EAP-Request/identity message 206, AP 106 forwards the identifier and password provided by MS 102 to AAA server 110 in a RADIUS-EAP-Response/Identity message 208. On receiving the identity message AAA server 110 chooses an EAP authentication method. The method involves one or more rounds of EAP authentication request messages 210, 212 that are conveyed from AAA server 110 to MS 102 and, in response, EAP authentication response messages 214, 216 that are conveyed from the MS to the AAA server. The EAP messages are carried in RADIUS messages between AAA server 110 and AP 106 and in EAPOL messages between AP 106 and MS 102. At the end of the final exchange of authentication requests and authentication responses, AAA server 110 authenticates MS 102 based on one or more well known user identifiers, such as a password, a shared secret, a public key, or a digital certificate, that is stored in database 112. If AAA server 110 can successfully authenticate MS 102, then AAA 110 conveys a RADIUS-EAP-Success message 218 to AP 106. Upon receiving the RADIUS-EAP-Success message 218, AP 106 conveys an EAPOL-EAP-Success message 220 to MS 102 and unblocks access to the MS 102. If AAA server 110 cannot successfully authenticate MS 102, then the AAA server conveys a RADIUS-EAP-Failure message to the AP 106. In this case, AP 106 continues to block access to MS 102.

With the increasing popularity of WLANs, WLANs are being set up in an increasing number of commercial establishments and public places, such as coffee houses, airports, libraries, schools, and convention centers. As diverse groups of people who subscribe to the services of a diversity of service providers express their desire to access WLAN services in such places, the need will evolve for the providers to provide overlapping services. However, currently no process is prescribed for a sharing of an AP. Instead, in the current state of the art, each provider provides a separate AP that is configured with, and broadcasts, its own SSID. Such a system is wasteful in that it forces service providers to provide redundant systems. Furthermore, the bandwidth available for provision of WLAN services is limited and prime WLAN locations, such as airports and convention centers, may not have sufficient bandwidth to support overlapping APs employed by each of multiple service providers.

In addition, the current state of the art permits a user to select a service provider based only on SSID. When a user is capable of accessing the networks of each of multiple service providers, the SSID alone may not provide the user with sufficient information to make a fully informed decision concerning which service provider to use. Furthermore, when the user performs a passive scan, the user may have to scan and process multiple beacons before selecting an SSID associated with a desired service provider, consuming an excessive amount of power of a limited life battery powering an MS.

Therefore a need exists for a method and apparatus that permits a user of an MS accessing a WLAN to select a service provider from among multiple service providers based on one or more criterion, such as services supported by each service provider, service costs, methods of billing, and a relationship between the visited network provider and the user's home network, and that further allows multiple service providers to share an AP.

### BRIEF DESCRIPTION OF THE DRAWINGS

FIG. 1 is a block diagram of an exemplary wireless local area network of the prior art.

FIG. 2 is a signal flow diagram of a prior art authentication process.

FIG. 3 is a block diagram of a wireless communication system in accordance with an embodiment of the present invention.

FIG. 4 is a block diagram of the mobile station of FIG. 3 in accordance with an embodiment of the present invention.

FIG. 5 is a signal flow diagram of an authentication process performed by the wireless communication system of FIG. 3 in accordance with an embodiment of the present invention.

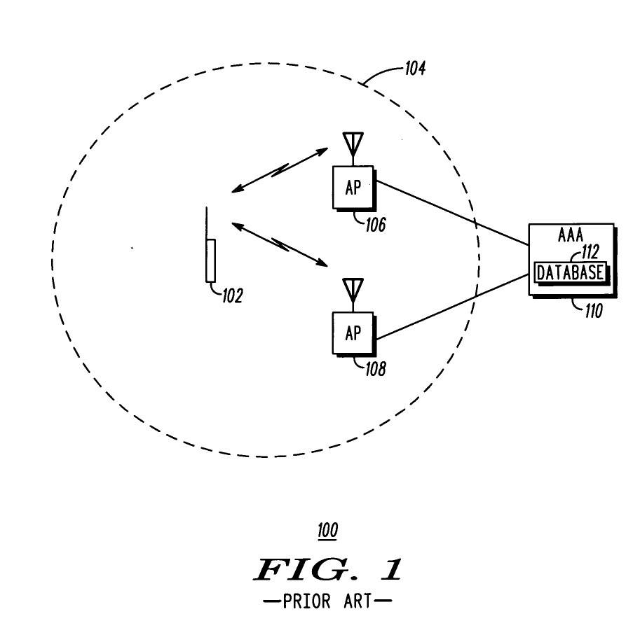

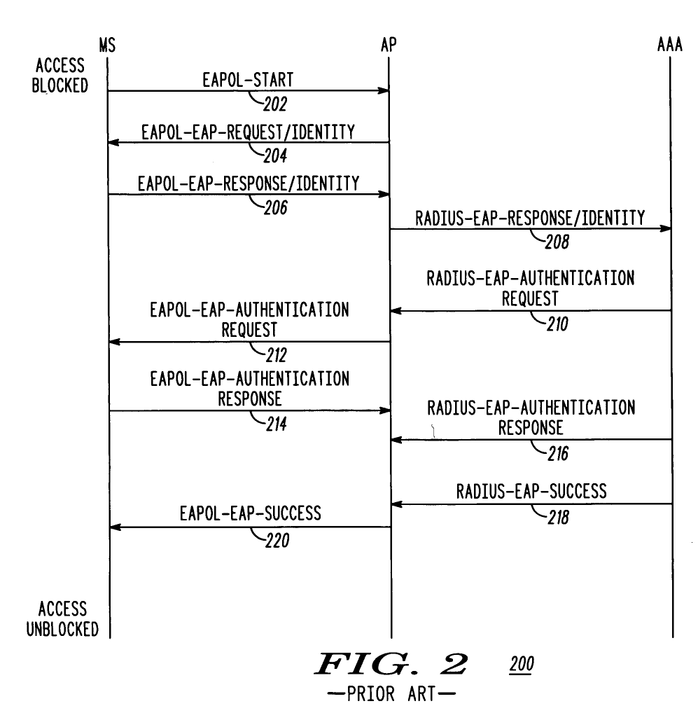

### DETAILED DESCRIPTION OF THE INVENTION

To address the need for a method and an apparatus that that permits a user of an MS accessing a wireless local area network (WLAN) to select a service provider from among multiple service providers based on one or more criterion, such as services supported by each service provider, service costs, methods of billing, and a relationship between the visited network provider and the users home network, and that further allows multiple service providers to share an AP, a WLAN communication system that includes an access point in communication with a mobile station and at least one Authentication, Authorization, and Accounting (AAA) server provides an authentication process whereby a user of the mobile station may select a WLAN service provider from among one or more WLAN service providers and/or one or more 3GPP service providers before being authenticated and further to make a decision to subscribe to the services of the selected service provider based on network service information, other than or in addition to an Service Set Identifier (SSID), associated with the selected service provider.

Generally, an embodiment of the present invention encompasses a method for providing network service information to a user of a mobile station accessing a wireless local area network. The method includes receiving a request to authenticate the mobile station and, in response to receiving the request, conveying network identification and service information with respect to each service provider of a plurality of service providers to the mobile station.

Another embodiment of the present invention encompasses a method for accessing a wireless local area network. The method includes conveying a request to authenticate a mobile station, receiving network identification and service information with respect to a service provider, and determining whether to access the wireless local area network based on the received network identification and service information.

Yet another embodiment of the present invention encompasses an Access Point in a wireless local area network. The Access Point includes a memory and a processor coupled to the memory. The memory stores an identifier and network service information in association with each service provider of a plurality of service providers. The processor assembles one or more messages comprising the service provider identifier and the network service information associated with each service provider of a plurality of service providers and conveys the one or more messages to a mobile station.

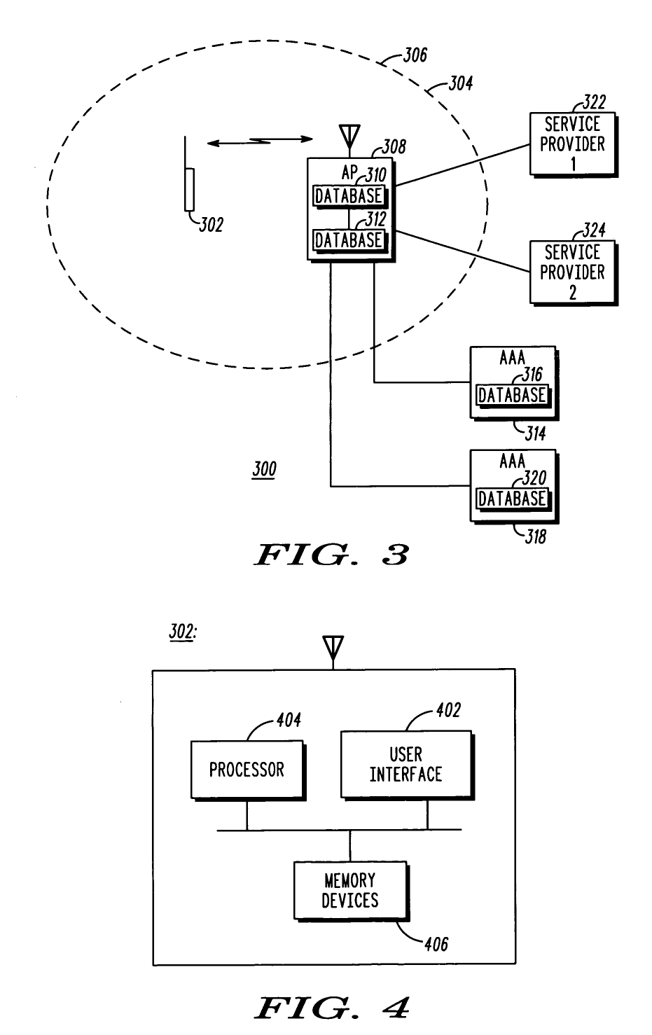

The present invention may be more filly described with reference to FIGS. 3-5. FIG. 3 is a block diagram of a wireless communication system 300 in accordance with an embodiment of the present invention. Communication system 300 comprises a wireless local area network (WLAN) 304 that includes a Basic Service Set (BSS) 306 comprising one or more Access Points (APs) 308 (one shown). AP 308 provides wireless communication services to user equipment (UEs), that is, mobile stations (MSs), such as MS 302, located in a coverage area serviced by the AP. Preferably MS 302 is a portable, mobile, or cellular communication device, such as but not limited to a cellular telephone, a radiotelephone, or a wireless modem that is included in or coupled to data terminal equipment, such as a personal computer, a laptop computer, a workstation, a printer, or a facsimile machine, that is capable of operating in a WLAN communication system. BSS 306 and AP 308 are shared by, that is, provide wireless communication services on behalf of, multiple public and/or private network service providers 322, 324 (two shown) capable of interworking with a WLAN network, such as but not limited to 3GPP (Third Generation Partnership Project), 3GPP2, and enterprise network service providers, that allow the MS to communicate with a corresponding external network operably coupled to the AP.

Communication system 300 further includes one or more Authentication, Authorization, and Accounting (AAA) servers 314, 318 (two shown) that are operably coupled to WLAN 304, and in particular to AP 308, and that provide authentication, authorization, and accounting services to the WLAN. Each AAA server of the multiple AAA servers 314, 318 is associated with one of the multiple service providers 322, 324 associated with BSS 306 and AP 308. Each AAA server 314, 318 includes a respective database 316, 320 that stores identifiers associated with each mobile station (MS) that is authorized to access WLAN 304 and further stores, in association with each identifier, a password and related billing information, such as a home service provider associated with the MS. In another embodiment of the present invention, AP 308, or BSS 306 and AP 308, may provide wireless communication services on behalf of only a single WLAN service provider, such as service provider 322.

AP 308 includes a processor 310, such as one or more microprocessors, microcontrollers, digital signal processors (DSPs), combinations thereof or such other devices known to those having ordinary skill in the art. AP 308 further includes one or more memory devices 312 associated with processor such as random access memory (RAM), dynamic random access memory (DRAM), and/or read only memory (ROM) or equivalents thereof, that store data and programs that may be executed by the processor. Memory devices 312 further store, in association with each service provider 322, 324 associated with the AP, an address of an AAA server 314, 318 associated with the service provider, a service provider identifier or network identifier, preferably a Service Set Identifier (SSID), and network service information, such as information concerning services supported by the service provider, a cost of each service supported by the service provider, methods of billing for the provided services, and a relationship between each service provider and users' home service providers, such as any extra fees the service provider may assess for use of the service provider's network, that is, a visited network, by subscribers to other service providers, that is, a home network.

FIG. 4 is a block diagram of MS 302, in accordance with an embodiment of the present invention. MS 302 includes a user interface 402 coupled to a processor 404, such as one or more microprocessors, microcontrollers, digital signal processors (DSPs), combinations thereof or such other devices known to those having ordinary skill in the art. User interface 402 provides a user of the MS with the capability of interacting with the MS, including inputting instructions into the MS. In one embodiment of the present invention, user interface 402 includes a display screen that comprises a touch screen that is able to determine a position (i.e., an X-coordinate and a Y-coordinate) of a user's touch on the touch screen and convey the position data to processor 404. Based on the position data, processor 404 then translates the user's touch into an instruction. In another embodiment of the present invention, user interface 402 may include a display screen and a keypad.

MS 302 further includes one or more memory devices 406 associated with processor 404, such as random access memory (RAM), dynamic random access memory (DRAM), and/or read only memory (ROM) or equivalents thereof, that store data and programs that may be executed by the processor. Memory devices 406 further store an MS identifier that is uniquely associated with the MS and an SSID and a corresponding authentication identifier, such as a password, a shared secret, key, a digital certificate, etc., associated with each service provider, such as one or more of service providers 322, 324, subscribed to by MS 302. In addition, memory devices 406 store instructions for assembling messages that are exchanged by the MS with WLAN 304.

Preferably, communication system 300 operates in accordance with the Institute for Electrical and Electronic Engineers (IEEE) 802.11 standards for WLAN communication systems, and in particular the IEEE P802.1X/D11 and 802.11i/D2 standards, which standards are hereby incorporated herein in their entirety and are available from the IEEE administrative offices in Piscataway, N.J., or on-line at standards.ieee.org. In addition, communication system 300 preferably further operates in accordance with the Third Generation Partnership Project (3GPP) requirements for WLAN-Cellular Interworking standards (TR 22.934 and TR 23.934), which standards are available from the 3GPP at ETSI, Mobile Competence Centre, 650, route des Lucioles, 06921 Sophia-Antipolis Cedex, France, or on-line at 3gpp.org, the Internet Engineering Task Force (IETF) RFC (Request For Comments) 2284, which is available from the IETF offices in Reston, Va., or on-line at ietf.org/rfc and describes a medium access control (MAC) layer Extensible Authentication Protocol (EAP) that provides for MAC layer negotiation of an Authentication Protocol for authenticating a peer before allowing Network Layer protocols to transmit over a link, which standards and protocols are hereby incorporated herein in their entirety, and the IETF memoranda “EAP AKA Authentication,” by H. Haverinen, dated February 2002, and “EAP SIM Authentication,” by H. Haverinen, dated June 2002.

In order for MS 302 to obtain access to WLAN 304, the MS first establishes a communication link with the WLAN in accordance with well known link establishment and configuration techniques. Upon establishing the link, communication system 300 authenticates MS 302 before authorizing the MS to transmit data traffic. In the prior art, in order to subscribe to the services of a WLAN, the authentication process merely allowed a user of an MS to make a subscription decision on a basis of an SSID of an associated service provider. Unlike the prior art, communication system 300 provides an authentication process whereby a user of MS 302 may select a WLAN service provider from among one or more WLAN service providers and/or one or more 3GPP service providers before being authenticated and further to make a decision to subscribe to the services of the selected service provider based on network service information, other than or in addition to an Service Set Identifier (SSID), associated with the selected service provider.

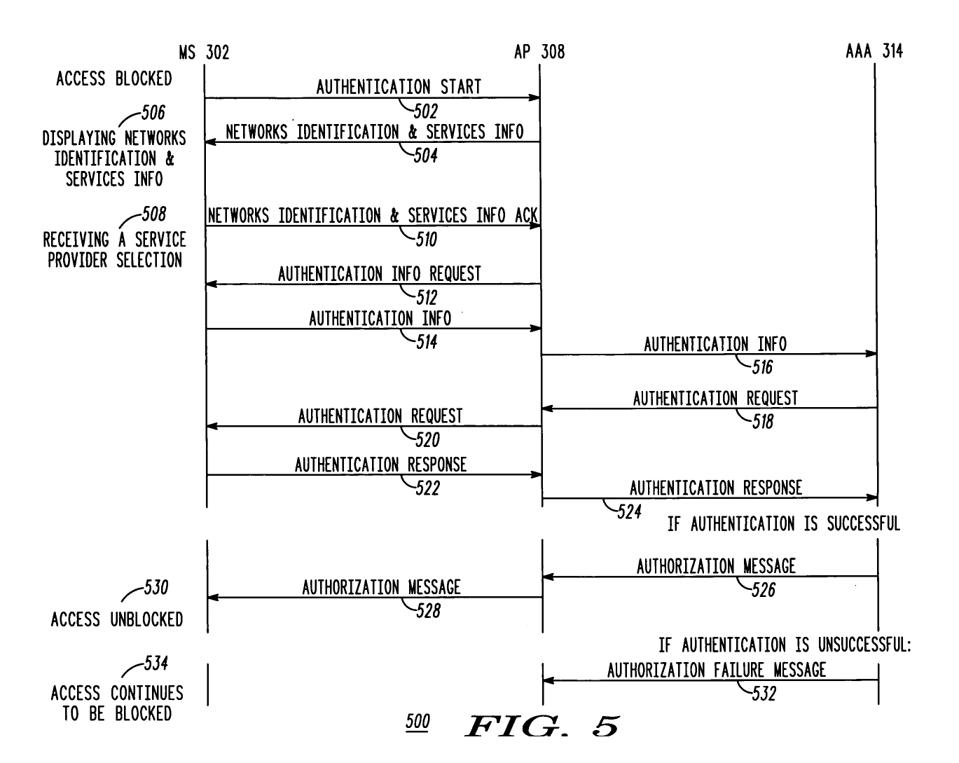

FIG. 5 is a signal flow diagram 500 of an authentication process executed by communication system 300 in accordance with an embodiment of the present invention. The authentication process begins when the MS transmits an authentication procedure start message 502, preferably an EAPOL (Extensible Application Protocol Over LAN)-Start message, to WLAN 304, and in particular to AP 308. Upon receiving authentication procedure start message 502, AP 308, an in particular processor 310 of the AP, retrieves from memory 312 network identification and service information concerning each service provider associated with the AP, such as service providers 322 and 324. AP 308 then conveys the retrieved network identification and service information to MS 302 in a network identification and services information message 504, preferably an EAPOL-EAP-Request/Information message.

Upon receiving network identification and services information message 504, MS 302 displays 508, in the display screen of user interface 402, at least a portion of the received network identification and service information in association with the corresponding service provider 322, 324. By displaying the network identification and services information, MS 302 permits a user of the MS to make an informed selection of the service provider subscribed to for a particular communication session instead of being limited to making a selection merely based on SSIDs. Furthermore, by providing MS 302 with network identification and service information corresponding to each service provider 322, 324 associated with AP 308 at the outset of the authentication process, system 300 reduces the need for MS 302 to individually solicit the network service information of each service provider associated with a BSS by providing an AP with a single SSID and receiving, in return, the network service information corresponding to the provided SSID.

Based on the information displayed on user interface 402 of MS 302, a user of the MS is then able to decide whether to access WLAN 304. Upon determining to access the WLAN, the user inputs to MS 302, and the MS receives 508 from the user, a selection of a service provider. For example, the user may input his or her selection by selecting a softkey or a text message displayed on the display screen of the user interface or by depressing a key in a keypad of the user interface. In another embodiment of the present invention, wherein AP 308 provides wireless communication services on behalf of only a single service provider, the user of MS 302 may not need to input a selection of a service provider and may instead input an indication of a desire to access WLAN 304. In yet another embodiment of the present invention, the user or a vendor of the MS may store service preferences in memory devices 406 of MS 302. The stored preferences may then be used by MS 302 to automatically select a service provider or determine whether to access WLAN 304 based on the network and services information received by the MS from AP 308.

Upon receiving network services information message 504, MS 302 acknowledges receipt of the message by conveying an acknowledgment 510, preferably an EAPOL-EAP-Response/Information/ACK message, back to AP 308. Upon receiving acknowledgment 510, AP 308 conveys a message 512 to MS 302 requesting authentication information from the MS, such as an identifier uniquely associated with the MS, an SSID associated with a selected service provider, and a password. Preferably the message 512 requesting authentication information is an EAPOL-EAP-Request/Identity message. Upon receiving message 512 requesting authentication information and upon receiving a selection of a service provider from a user of the MS, receiving an indication of the user's desire to access WLAN 304, or automatically selecting a service provider or determining to access WLAN 304, MS 102 transmits a message 514 providing the requested authentication information, preferably an EAPOL-EAP-Response/Identity message that includes the identifier of the selected network, that is, the SSID, and at least a portion of the received network identification and services information. By providing the SSID and the at least a portion of the received network identification and services information, MS 302 provides WLAN 304, and in particular AP 308, with the selected service provider. Based on the SSID and information received from the MS, the WLAN is able to determine an appropriate AAA server 314, 318 for authenticating the MS.

Upon receiving the requested authentication information, AP 308 is able to determine an appropriate AAA server 314, 318 for performing authentication. AP 308 then forwards the identifier and password provided by MS 302 to the AAA server associated with the selected service provider, such as AAA server 314, in an authentication information message 516, preferably a RADIUS-EAP-Response/Identity message. Similar to communication system 100, upon receiving authentication information message 516, AAA server 314 then chooses an EAP authentication method by which the AAA server authenticates MS 302. The EAP authentication method involves one or more rounds of EAP authentication request messages 518, 520 that are respectively conveyed from AAA server 314 to AP 308 and from AP 308 to MS 302 and, in response, EAP authentication response messages 522, 524 that are respectively conveyed from the MS to the AP and from the AP to the AAA server. In one embodiment of the present invention, the EAP messages are MAC layer messages or data link layer messages that are carried in RADIUS protocol messages between AAA server 314 and AP 308 and in EAPOL messages between AP 308 and MS 302. In another embodiment of the present invention, the EAP messages exchanged between AAA server 314 and AP 308 are MAC layer messages or data link layer messages that are carried in Diameter protocol messages.

At the end of the final exchange of authentication requests and authentication responses, AAA server 314 authenticates MS 302 based on one or more well known authentication identifiers, such as a password, a shared secret, a public key, or a digital certificate, that is stored in the AAA's database 316. If AAA server 314 can successfully authenticate MS 302, then AAA server 314 conveys an authorization message 526, preferably RADIUS-EAP-Success message, to AP 308 authorizing the AP to unblock access to MS 302. Upon receiving authorization message 526, AP 308 conveys an authorization message 528, preferably an EAPOL-EAP-Success message, to MS 302 authorizing the MS to access WLAN 304 and unblocks 530 access to MS 302. If AAA server 314 cannot successfully authenticate MS 302, then the AAA server conveys an authorization failure message 532, preferably a RADIUS-EAP-Failure message, to the AP 308. In this case, AP 308 continues to block 534 access to MS 302.

In summary, WLAN communication system 300 provides an authentication process whereby a user of MS 302 may select a WLAN service provider from among one or more WLAN service providers and/or one or more 3GPP service providers 322, 324 sharing the WLAN before being authenticated and further to make a decision to subscribe to the services of the selected service provider based on network service information, other than or in addition to an Service Set Identifier (SSID), associated with the selected service provider. As part of the authentication process, WLAN 304 provides to the MS network identification and services information concerning the one or more service providers, such as services supported by each service provider, service costs, methods of billing, and a relationship between the visited network provider and the user's home network, thereby allowing the user of the MS to make an informed selection of a WLAN service provider. The MS may then select a service provider from among the one or more service provider and inform the WLAN of the selected service provider by conveying to the WLAN an associated SSID and at least a portion of the received network identification and services information. Based on the SSID and information received from the MS, the WLAN is able to determine an appropriate AAA server 314, 318 for authenticating the MS.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for providing network service information to a user of a mobile station accessing a wireless local area network comprising:
receiving a request to authenticate the mobile station; and
in response to receiving the request, conveying network identification and service information with respect to each service provider of a plurality of service providers to the mobile station.

2. The method of claim 1, wherein the request to authenticate the mobile station and the network identification and service information are each conveyed in a medium access control layer message.

3. The method of claim 2, wherein the request to authenticate the mobile station comprises an Extensible Application Protocol Over Lan-Start message and the network service information is conveyed in an Extensible Application Protocol Over Lan-Extensible Application Protocol-Request/Information message.

4. The method of claim 1, further comprising:
requesting authentication information; and
receiving the requested authentication information from the mobile station.

5. The method of claim 4, wherein receiving the requested authentication information comprises receiving a selection of a service provider from among the plurality of service providers.

6. The method of claim 4, wherein medium access control layer messages are used to request the authentication information and to receive the requested authentication information.

7. The method of claim 6, wherein the authentication information is requested in an Extensible Application Protocol Over Lan-Extensible Application Protocol-Request/Identity message and the requested authentication information is received in an Extensible Application Protocol Over Lan-Extensible Application Protocol-Response/Identity message.

8. The method of claim 4, further comprising requesting authorization of the mobile station.

9. The method of claim 4, further comprising:
determining an Authentication, Authorization, and Accounting server based on the received authentication information; and
requesting authorization of the mobile station by the determined Authentication, Authorization, and Accounting server.

10. A method for accessing a wireless local area network comprising:
conveying a request to authenticate a mobile station;
receiving network identification and service information with respect to a service provider; and
determining whether to access the wireless local area network based on the received network identification and service information.

11. The method of claim 10, further comprising:
displaying at least a portion of the received network identification and service information to the user of the mobile station; and
in response to displaying the at least a portion of the received network identification and service information, receiving an indication of a desire to access the wireless local area network.

12. The method of claim 10, wherein determining comprises determining whether to access the wireless local area network based on the received network identification and service information and further based on stored preferences.

13. The method of claim 10, wherein the request to authenticate the mobile station and the network identification and service information are each conveyed in a medium access control layer message.

14. The method of claim 13, wherein the request to authenticate the mobile station comprises an Extensible Application Protocol Over Lan-Start message and the network service information is conveyed in an Extensible Application Protocol Over Lan-Extensible Application Protocol-Request/Information message.

15. The method of claim 10, further comprising:
receiving a request for authentication information; and
conveying the requested authentication information.

16. The method of claim 15, wherein receiving network identification and service information with respect to a service provider comprises receiving network identification and service information with respect to each service provider of a plurality of service providers and wherein conveying the requested authentication information comprises conveying a selection of a service provider from among the plurality of service providers.

17. The method of claim 15, wherein medium access control layer messages are used to request the authentication information and to convey the requested authentication information.

18. The method of claim 17, wherein the authentication information is requested in an Extensible Application Protocol Over Lan-Extensible Application Protocol-Request/Identity message and the requested authentication information is conveyed in an Extensible Application Protocol Over Lan-Extensible Application Protocol-Response/Identity message.

19. The method of claim 15, further comprising receiving authorization to convey data traffic to the wireless local area network.

20. An Access Point in a wireless local area network comprising:
a memory that stores an identifier and network service information in association with each service provider of a plurality of service providers; and
a processor coupled to the memory that assembles one or more messages comprising the service provider identifier and the network service information associated with each service provider of a plurality of service providers and conveys the one or more messages to a mobile station.

21. The Access Point of claim 20, wherein the one or more messages comprise medium access layer messages.

22. The Access Point of claim 20, wherein the processor receives a request to authenticate the mobile station and, in response to receiving the request, assembles the one or more messages.

23. The Access Point of claim 22, wherein the one or more messages comprises a first one or more messages and wherein the processor further assembles a second message comprising a request for authentication information and conveys the second message to the mobile station.

24. The Access Point of claim 23, wherein the processor further, in response to conveying the request for authentication information, receives the requested authentication information and, in response to receiving the requested authentication information, assembles a third message requesting authorization of the mobile station and conveys the third message to a server.

25. The Access Point of claim 24, wherein the memory further stores, in association with the server, a service provider identifier, wherein the received authentication information comprises the service provider identifier, and wherein the processor determines the server based on the received service provider identifier.
